(19) United States
(12) Patent Application Publication
(10) Pub. No.: US 2026/0092801 A1
(43) Pub. Date: Apr. 2, 2026

(54) SENSOR FOR LEVEL DETECTION

(71) Applicant: NATIONAL RESEARCH COUNCIL OF CANADA, Ottawa (CA)

(72) Inventors: Ryan Griffin, Ottawa (CA); Neil Graddage, Ottawa (CA)

(21) Appl. No.: 19/113,826

(22) PCT Filed: Oct. 6, 2023
(86) PCT No.: PCT/IB2023/060070

§ 371 Date: Mar. 20, 2025

(30) Foreign Application Priority Data
Oct. 7, 2022 (CA) 3182687

(51) Int. Cl. G01F 23/263; G01F 23/80

(52) U.S. Cl. CPC G01F 23/266; G01F 23/804

(57) ABSTRACT

An example sensor includes: at least three capacitive sensing segments applied to the container; and a processor connected to the at least three capacitive sensing segments, the processor configured to: obtain respective capacitance measurements from the at least three capacitive sensing segments; determine an orientation of the container based on the capacitance measurements; and determine the amount of the substance based on the capacitance measurements.

### FIELD

The specification relates generally to devices for determining the level of a substance in a container, and more particularly to a capacitive sensor for determining the orientation of a container and a level of a substance in the container.

### BACKGROUND

Detection of liquid level in a container is used for a variety of applications. In the medication adherence field, existing commercial technologies for medication administration and dosage detection rely on monitoring cap opening, and do not detect and report liquid level in medicine containers. Existing non-contact methods of measuring the liquid contained within a container typically require the container to be at a specific orientation, and extra sensors are required to detect this.

### SUMMARY

According to an aspect of the present specification an example sensor includes: at least three capacitive sensing segments applied to the container; and a processor connected to the at least three capacitive sensing segments, the processor configured to: obtain respective capacitance measurements from the at least three capacitive sensing segments; determine an orientation of the container based on the capacitance measurements; and determine the amount of the substance based on the capacitance measurements.

According to another aspect of the present specification, an example method includes: obtaining respective capacitance measurements from at least three capacitive sensing segments applied to a container; determining an orientation of the container based on the capacitance measurements; and determining an amount of a substance in the container based on the capacitance measurements.

According to another aspect of the present specification, an example sensor for a container includes: at least three capacitive sensing segments applied to the container and extending along an axial length of the container; and a processor connected to the at least three capacitive sensing segments, the processor configured to: obtain respective capacitance measurements from the at least three capacitive sensing segments; and determine an orientation of the container based on the capacitance measurements.

BRIEF DESCRIPTION OF DRAWINGS

Implementations are described with reference to the following figures, in which:

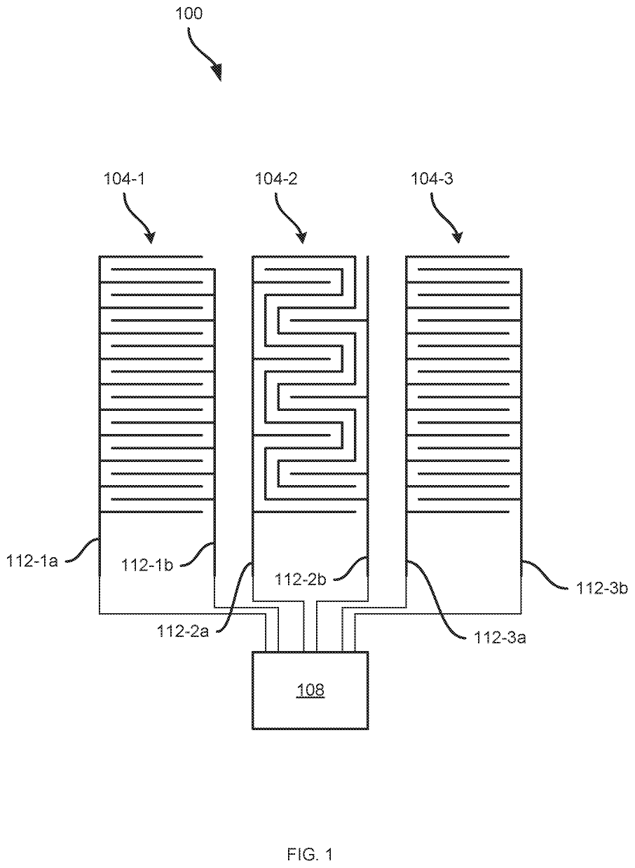

FIG. 1 depicts an example sensor in accordance with the present disclosure.

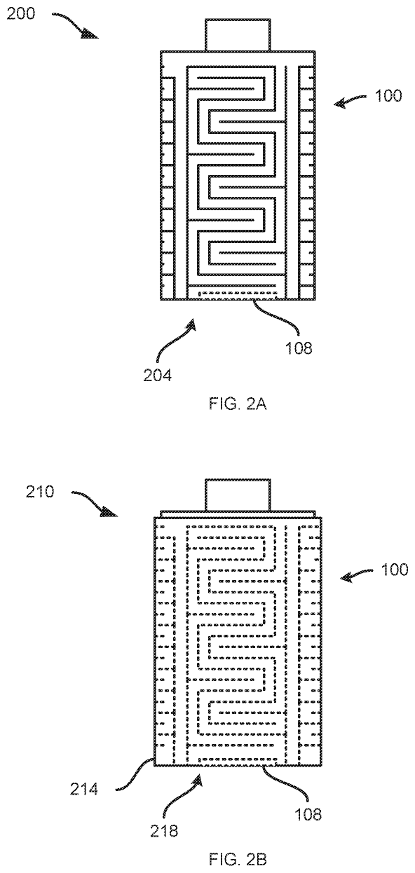

FIG. 2A depicts the sensor of FIG. 1 applied to a container.

FIG. 2B depicts the sensor of FIG. 1 applied to a label.

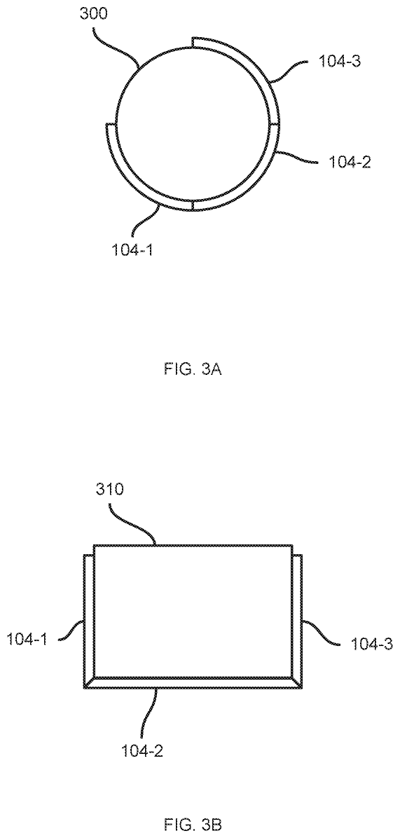

FIG. 3A depicts an example configuration of the sensor of FIG. 1 applied to a container having a circular cross section.

FIG. 3B depicts an example configuration of the sensor of FIG. 1 applied to a container having a rectangular cross section.

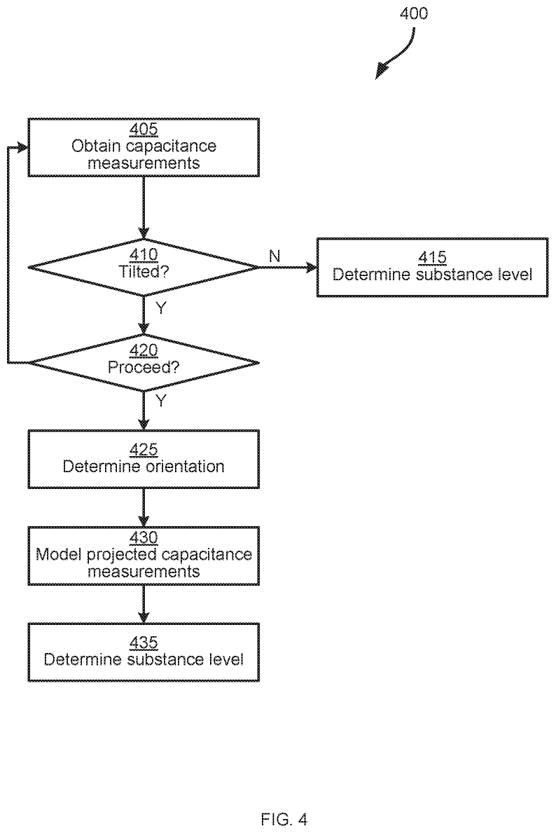

FIG. 4 depicts a flowchart of an example method of detecting an orientation of a container and a level of a substance in the container.

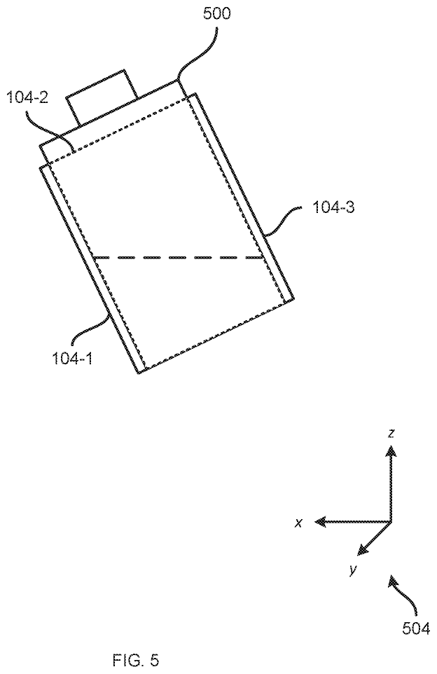

FIG. 5 depicts a schematic diagram of a tilted container.

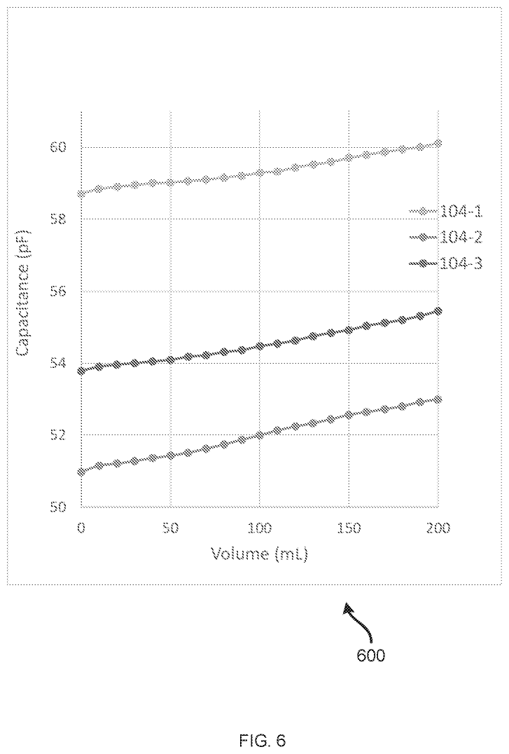

FIG. 6 depicts an example plot of capacitance measurements.

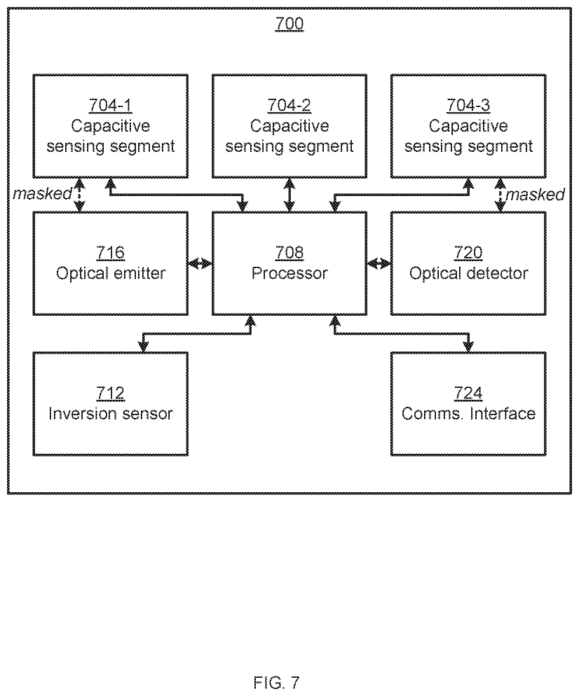

FIG. 7 depicts a schematic block diagram of an example sensing system in accordance with the present disclosure.

### DETAILED DESCRIPTION

Some liquid level sensors use a capacitive sensing element to determine the liquid level. Such capacitive sensing elements may only obtain accurate results when the container is in a neutral orientation (i.e., vertical), and accordingly, sensing systems may further include an orientation sensor, such as an accelerometer, to verify that the orientation is suitable for a level detection operation. However, the addition of electronic components adds manufacturing complexity and energy requirements, as well as added space requirements on the container and additional electronic waste.

In accordance with the present disclosure, an example sensor may include at least three capacitive sensing elements arranged to form a plane to allow the sensor to serve a dual purpose of both detecting an orientation of the container to which the sensor is applied, as well as detecting the substance level of the substance in the container.

FIG. 1 depicts an example capacitive sensor 100 (also referred to herein as simply the sensor 100) configured for dual operation to detect the orientation of a container, as well as to detect the amount (or level) of a substance in the container in accordance with the present disclosure.

The sensor 100 includes a plurality of capacitive sensing segments, of which three example segments 104-1, 104-2, and 104-3 (referred to herein collectively as segments 104 and generically as a segment 104; this nomenclature is also used elsewhere herein), are depicted. More particularly, the sensor 100 includes at least three capacitive segments 104, and in other examples, may include more than three.

The capacitive sensing segments 104 are connected to a processor 108 configured to obtain capacitance measurements from the segments 104 and determine the orientation of the container and the level of the substance in the container, as will be described further herein. The processor 108 may be a microcontroller, a microprocessor, a processing core, combinations of the above, or the like. The processor 108 may cooperate with a memory (not shown) storing machine-readable instructions which when executed, cause the processor 108 to realize the functionality described herein. Some or all of the memory may be integrated with the processor 108. The processor 108 and the memory may comprise one or more integrated circuits.

The capacitive sensing segments 104 each include two traces 112 having respective contacts connected to the processor 108. In particular, the segment 104-1 includes traces 112-1a and 112-1b, the segment 104-2 includes traces 112-2a and 112-2b, and the segment 104-3 includes traces 112-3a and 112-3b.

The traces 112 of each respective capacitive sensing segment 104 may be interleaved to increase the sensitivity of each segment 104. For example, the traces 112 may have interdigitated (e.g., as depicted in the segments 104-1 and 104-3) or serpentine (e.g., as depicted in the segment 104-2) configurations. The traces 112 for each segment 104 within the sensor 100 may, in some examples, be configured with a consistent pattern (e.g., interdigitated or serpentine), or the patterns for the traces 112 of each segment 104 may be selected independently.

In some examples, the sensor 100 may further include or be interconnected with a wireless communications interface, including suitable hardware (e.g., transmitters, receivers, network interface controllers, and the like) to allow the sensor 100 to communicate with other computing devices. Similarly, the sensor 100 may include or be interconnected with one or more input and/or output devices, including buttons, display screens, speakers, and the like.

In operation, the sensor 100, and more particularly the segments 104, is configured to be applied to the container to act as a dual purpose sensor. In particular, the sensor 100 is configured to determine the orientation of the container. That is, the sensor 100 may determine whether the container is tilted or otherwise varied from a neutral orientation in which a longitudinal axis of the container (i.e., extending along an axial length or a z-axis of the container) differs from vertical (i.e., perpendicular to the ground plane, or parallel to the direction of gravity).

The sensor 100 is further be configured to detect the amount or level of the substance in the container. For example, the container may be a medicine vial containing a liquid medication, and hence the sensor 100 may be configured to determine the amount of the liquid medication remaining in the container. In other examples, the sensor 100 may be applied to other suitable containers containing other types of substances.

Referring to FIG. 2A, an example container 200 is depicted, having the sensor 100 is applied to the container 200 to detect the orientation of the container 200 and a level of a substance contained in the container 200, in accordance with the present disclosure. In particular, in the present example, the traces 112 of the sensor 100 are applied directly onto the container 200. For example, the traces 112 may be etched or printed directly onto a plastic or glass exterior surface or wall of the container 200. In other examples, the traces 112 may otherwise be directly applied (e.g., by other printing methodologies or the like) to the container 200. In such examples, the processor 108 may be adhered to or integrally formed with a base 204 of the container 200, or another suitable surface or wall of the container 200 (e.g., to substantially protect the processor 108 from damage).

Referring to FIG. 2B, another example container 210 is depicted, having the sensor 100 applied to the container 210 to detect the orientation of the container 210 and a level of a substance contained in the container 210, in accordance with the present disclosure. In particular, in this example, the sensor 100, and more particularly, the traces 112, are applied to a substrate 214, which in turn is applied to the container 210. For example, the substrate 214 may be a conformable material (e.g., paper-based or the like) to conform to the shape of the container 210.

For example, the substrate 214 may be a label or the like for a medication contained in the container 210. Accordingly, the traces 112 may be etched or printed onto a rear surface of the substrate 214, to allow a front surface of the substrate 214 to contain information to be presented to users (e.g., patient information, dosage regimes, etc.). Further, the rear surface of the substrate 214 may include an adhesive layer configured to allow the substrate 214 to be adhered to the container 210. In other examples, the substrate 214 may include multiple layers, having the traces 112 of the sensor 100 sandwiched therebetween. In such examples, the substrate 214 may include a base section configured to support the processor 108 at or near a base 218 of the container 210, or another suitable surface or wall of the container 210 (e.g., to substantially protect the processor 108 from damage).

Specifically, when the sensor 100 is applied to a container (e.g., the container 200 or the container 210), the segments 104 are configured to extend along an axial length of the container. That is, lengths (e.g., fingers of the interdigitated pattern or lengths of the serpentine pattern) of the traces 112 of a respective segment 104 may be parallel to one another and spaced from one another in the longitudinal direction (i.e., along the axial length) of the container. The spaces between lengths of opposing traces 112 of a respective segment 104 may be minimized according to manufacturing tolerances to increase the sensitivity of the capacitive sensing segments 104 to capacitance changes.

Further, the segments 104 are spaced from one another about the container such that the capacitance measurements obtained from the segments 104 allow a plane to be defined. In particular, the segments 104 are non-coplanar with one another. Further, if the segments 104 are planar, the plane of at least one of the segments 104 intersects the planes of the other two. Such a configuration of the segments 104 allow the sensor 100 to detect deviation of the longitudinal axis (i.e., the z-axis) from vertical in either the x-direction or the y-direction.

For example, FIG. 3A depicts a cross-sectional view of an example container 300 having a substantially circular cross-section. The segments 104-1, 104-2, and 104-3 may be applied circumferentially about the container 300. Since none of the segments 104 are coplanar, this configuration allows the sensor 100 to detect deviations in both the direction and the y-direction.

FIG. 3B depicts a cross-sectional view of another example container 310 having a substantially rectangular cross-section. The segments 104 may be applied to three different surfaces (i.e., edges of the rectangular cross-section) of the container 310 so that none of the segments 104 are coplanar, and the plane of the segment 104-2 intersects the planes of the segments 104-1 and 104-3, allowing the sensor 100 to detect deviations in both the x-direction and the y-direction.

Turning now to FIG. 4, the functionality implemented by the sensor 100 will be discussed in greater detail. FIG. 4 illustrates a method 400 of detecting an orientation of a container and determining an amount of a substance in the container. The method 400 will be discussed in conjunction with its performance by the sensor 100, for example as applied to the container 200 or 210. In other examples, the method 400 may be performed by other suitable devices or in other suitable systems.

The method 400 begins at block 405, for example in response to an initiation condition for detecting the level of the substance in the container. For example, the processor 108 may determine whether a regular predefined interval of time has elapsed (e.g., every 30 minutes, at a set time once per day, etc.), whether a request has been received (e.g., by a remote device, or at an input device at the container), or whether another suitable initiation condition has been detected (e.g., based on detection of removal of a cap of the container, or the like). In some examples, the processor 108 may obtain preliminary capacitance measurements as part of the assessment of the initiation condition. In particular, the initiation condition may be met if the preliminary capacitance measurements are within a predefined range of values (e.g., to exclude conditions in which the container is being held by a user, which may result in high capacitance measurements), and/or that the preliminary capacitance measurements have been maintained, such as by being within a threshold percentage of a previous measurement, for a predefined amount of time (e.g., 10 seconds, 1 minute, etc.) to verify that the container is in a steady state for measurement, and is not being moved or carried around or similar. In response to the initiation condition, the processor 108 obtains a capacitance measurement from each of the at least three capacitive sensing segments 104.

At block 410, the processor 108 determines whether the container is tilted (i.e., whether the orientation of the container deviates from a neutral orientation) based on the capacitance measurements obtained at block 405. For example, the processor 108 may determine whether the capacitance measurements meet a tilt condition. The tilt condition may include a comparison of the capacitance measurements to one another, or a comparison of normalized capacitance measurements to one another. For example, if the capacitive sensing segments 104 are different shapes or sizes, or have their traces in different configurations or patterns, the capacitance measurements obtained by the different segments 104 may still be unequal. Accordingly, the capacitance measurements may first be normalized based on the specific arrangement of the capacitive sensing segment 104 prior to comparison to other normalized capacitance measurements. For example, the capacitance measurements may be normalized to represent a percentage of the respective capacitive sensing segment 104 is covered by the substance in the container.

To accurately assess the tilt condition, the sensor 100 may be calibrated for a specific combination of the sensor 100 as applied to a specific container. The calibration capacitance measurements may be stored in a lookup table or similar at the processor 108. Further, the application of the sensor 100 to the container may be carefully controlled to minimize variation and increase the accuracy of the resulting capacitance measurements obtained. In some examples, the sensor 100 may include additional capacitive sensing segments 104 or other types of sensor devices to increase the number of data points obtained, thereby increasing the accuracy of the orientation determination.

If the capacitance measurements (or normalized capacitance measurements) from each of the capacitive sensing segments are substantially unequal, or outside of a threshold similarity (e.g., above a threshold percent difference) of one another, the tilt condition may be met, and the processor 108 may determine at block 410 that the container is tilted.

For example, referring to FIG. 5, an example container 500 is tilted in the x-z plane, as defined by the coordinate system 504. In particular, the sensor 100 as applied to the container 500 may include the first capacitive sensing segment 104-1 and the third capacitive sensing segment 104-2 applied perpendicular to the x-z plane in the coordinate system 504, while the second capacitive sensing segment 104-2 is applied parallel to the x-z plane. Accordingly, the first capacitive sensing segment 104-1 may detect a relative increase in capacitance, and the third capacitive sensing segment 104-3 may detect a relative decrease in capacitance, in comparison to the capacitance detected when the container 500 is a neutral or vertical orientation. Thus, the normalized capacitance measurements may be above a threshold percent difference of one another, and the processor 108 may determine that the container 500 is tilted.

In other examples, other computations may be performed on the capacitance measurements and/or other tilt conditions may be assessed to determine at block 410 whether the container is tilted.

Returning to FIG. 4, if the determination at block 410 is negative, that is, the processor 108 determines that the container is not tilted (i.e., that the container is in a neutral orientation), then the processor 108 proceeds to block 415 of the method 400. At block 415, the processor 108 uses the capacitance measurements obtained at block 405 to determine the amount or the level of the substance in the container. For example, the processor 108 may compare the capacitance measurement obtained from a primary or default capacitive sensing segment 104 and map the capacitance measurement to a volume of the container according to a predefined mapping (e.g., defined at a calibration stage and stored in a memory, or the like). In other examples, the processor 108 may use a combination of the capacitance measurements, for example by averaging the corresponding volumes to obtain a more accurate measure of the amount of the substance in the container, or by aggregating the capacitance measurements, such that the capacitive sensing segments 104 are treated as a single sensing element, and determining the corresponding volume or amount of the substance in the container based on the aggregated capacitance measurement.

For example, referring to FIG. 6, an example plot 600 of capacitance measurements and corresponding volume measurements for each of the capacitive sensing segments 104 is depicted. The processor 108 may map each capacitance measurement obtained by the respective capacitive sensing segment 104 to a projected volume and may average the projected volumes to determine the level of the substance in the container.

Returning again to FIG. 4, if the determination at block 410 is affirmative, that is, the processor 108 determines that the container is tilted, then the processor 108 proceeds to block 420 of the method 400. At block 420, the processor 108 determines whether or not to proceed with the substance level detection operation. If the processor 108 is incapable of proceeding with the substance level detection operation (e.g., based on computational complexity of the operation and the processing power of the processor 108), then the processor 108 may simply make a negative determination at block 420.

In other examples, the processor 108 may make the determination based on other rules or conditions. For example, the processor 108 may be configured to skip at most a threshold number of level detection operations or may make the determination based on the initiation condition at block 405, e.g., the processor 108 may make an affirmative determination if the initiation condition is a user-generated request for a level detection operation. In still further examples, the processor 108 may make the determination at block 420 based on detection of an error condition. For example, if any of the capacitive sensing segments 104 obtains a capacitance measurement corresponding to either full coverage of the segment 104 or no coverage of the segment 104, the processor 108 may determine that the container is on its side, and hence the sensor 100 may not be able to make a determination of the level or amount of the substance in the container. In other examples, other conditions and/or combinations of conditions may be applied to make the determination at block 420.

If the determination at block 420 is negative, that is, the processor 108 elects not to proceed with the level detection operation, then the processor 108 may skip the current level detection operation and return to block 405 to wait for another initiation condition. In some examples, the processor 108 may additionally generate a notification, such as an audio or visual alert, a message (e.g., including a particular error condition or the like) transmitted via wireless communications to another device or server, or similar.

If the determination at block 420 is affirmative, that is, the processor 108 elects to proceed with the level detection operation, then the processor 108 proceeds to block 425 of the method 400. At block 425, the processor 108 may optionally determine an orientation of the container, including determining a direction in which the container is tilted, as well as a tilt degree.

For example, referring again to FIG. 5, the processor 108 may determine that the container 500 is tilted in the x-z plane based on comparing the capacitance measurements obtained from segments 104. Specifically, a normalized percent coverage of the segments 104 may indicate that the difference in percent coverage of the first capacitive sensing segment 104-1 relative to the second capacitive sensing segment 104-2 is the same as the difference in percent coverage of the second capacitive sensing segment 104-2 relative to the third capacitive sensing segment 104-3. The processor 108 may therefore determine that the tilt is in a parallel plane to the second capacitive sensing segment 104-2. In other examples, if the container is tilted in a different direction, the processor 108 may compute a linear or other combination of contributions of each of the capacitive sensing segments 104 to determine the direction of tilt. The processor 108 may further determine the tilt degree, for example, based on the magnitude of the difference between percent coverage of each of the capacitive sensing segments 104.

Returning again to FIG. 4, at block 430, the processor 108 may model projected capacitance measurements based on the orientation of the container determined at block 425. That is, the processor 108 may model the container being filled to a series of predefined volumes at the determined orientation. The processor 108 may then determine, based on the model, the percent coverage of each of the capacitive sensing segments 104 at each of the predefined volumes, and thereby obtain the projected capacitance measurements for the capacitive sensing segment 104. Thus, the processor 108 may obtain a mapping between the projected capacitance measurements at the given orientation, and the volumes or amounts of the substance in the container.

At block 435, the processor 108 determines the amount or level of the substance based on the actual capacitance measurements obtained at block 405 and the projected capacitance measurements modelled at block 430. That is, the processor 108 may map the capacitance measurement for a given segment 104 to the corresponding projected capacitance measurements, and subsequently to the corresponding volume for the projected capacitance measurement, based on the model obtained at block 430. The processor 108 may use a single default or primary capacitive sensing segment 104 to determine the amount of the substance, or the processor 108 or may use an average of the determined amount of the substance based on capacitance measurements from a plurality of the segments 104.

In other examples, the determination at blocks 425, 430, and 435 of the amount or level of the substance when the container is tilted may be performed using other suitable methods. For example, some or all of the blocks 425-435 may be combined, performed in other orders than that depicted, skipped, or otherwise modified to allow the processor to determine the amount or level of the substance based on the capacitance measurements.

In some examples, the sensor and/or container and sensor system may include other components to further enhance the capabilities of the sensor. For example, referring to FIG. 7, a block diagram of another example sensing system 700 is depicted. The sensing system 700 includes at least three capacitive sensing segments 704-1, 704-2, and 704-3 connected to a processor 708. The segments 704 are similar to the segments 104 and may include interleaved traces (not shown). The processor 708 is similar to the processor 108.

The sensing system 700 may further include an inversion sensor 712 configured to detect total or partial inversion of the container to which the sensing system 700 is applied. For example, the inversion sensor 712 may be an additional electrode connected to the processor 708 and may be configured to be applied at a base of the container to detect whether the substance is detected at the base of the container. When the inversion sensor 712 detects a lack of signal, the processor 708 may determine that the container is totally or partially inverted, and may process the capacitance signals from the segments 704 accordingly in determining the amount or level of the substance in the container and the orientation of the container.

The sensing system 700 may further include an optical emitter 716 and an optical detector 720. The optical emitter 716 and the optical detector 720 are also connected to the processor 708 and may also be configured to perform an optical level detection operation to determine the amount or level of the substance in the container. In particular, the sensing system 700 may perform two independent level detection operations, by capacitive means and by optical means, and may verify the substance level based on a comparison of the two results. Preferably, the optical emitter 716 may be driven by an electrode of one of the segments 704, and similarly the optical detector 720 may be connected to an electrode of another (or the same) segment 704.

In some examples, the optical emitter 716 and/or the optical detector 720 may be arranged relative to one of the segments 704 to allow the corresponding segment 704 to mask the optical emitter 716 and/or the optical detector 720. That is, the interleaved lengths of the traces of the segment 704 is superimposed over the optical emitter 716 or the optical detector 720, thereby blocking portions of the emitter 716 and/or the detector 720. The masking may allow for patterned light to be emitted from the emitter 716, thereby allowing for more robust detection and differentiation of the detected light and increasing accuracy of the level detection operation. Similarly, the variances in detected light along the masked detector 720 may allow for better differentiation of changes in the detected light and may similarly increase the accuracy of the level detection operation.

The sensing system 700 may further include a wireless communications interface 724 configured for wireless communications, such as a Bluetooth or Bluetooth low energy or other similar communications protocol.

As described above, a sensor including at least three capacitive sensing segments may be applied to a container to act as a dual-purpose sensor. In particular, the sensor may be configured to determine an orientation of the container (i.e., whether the container is tilted) as well as to detect the amount or level of a substance contained within the container. The dual-purpose nature of a single sensor allows for the amount and volume of electronic components to be reduced, thereby also reducing electronic waste. Further, the orientation sensing capabilities of the sensor may allow a reduction in computational complexity of the level detection operation, for example by limiting the level detection operation to performance when the container is in an upright or neutral orientation.

The scope of the claims should not be limited by the embodiments set forth in the above examples but should be given the broadest interpretation consistent with the description as a whole.

1. A sensor comprising:
at least three capacitive sensing segments configured to be applied to a container; and
a processor connected to the at least three capacitive sensing segments, the processor configured to:
obtain respective capacitance measurements from the at least three capacitive sensing segments;
determine an orientation of the container based on the capacitance measurements; and
determine an amount of a substance in the container based on the capacitance measurements.

2. The sensor of claim 1, wherein each of the at least three capacitive sensing segments extends along an axial length of the container.

3. The sensor of claim 1, wherein each of the at least three capacitive sensing segments comprises interdigitated or serpentine traces.

4. The sensor of claim 1, wherein the at least three capacitive sensing segments are spaced from one another such that the capacitance measurements obtained from the at least three capacitive sensing segments allow a plane to be defined.

5. The sensor of claim 1, wherein the processor is configured to determine the amount of the substance when the orientation of the container is a neutral orientation.

6. The sensor of claim 5, wherein, to determine whether the orientation of the container is a neutral orientation, the processor is configured to determine whether the capacitance measurements are within a threshold similarity to one another.

7. The sensor of claim 5, wherein to determine the amount of the substance in the container, the processor is configured to aggregate the capacitance measurements and determine the amount of the substance based on the aggregated capacitance measurements.

8. The sensor of claim 1, wherein the processor is further configured to:
model projected capacitance measurements based on the orientation; and
determine the amount of the substance based on the capacitance measurements and the projected capacitance measurements.

9. The sensor of claim 1, further comprising an inversion sensor configured to detect an inversion of the container.

10. The sensor of claim 1, further comprising an optical detector and an optical emitter configured to perform an optical level detection operation.

11. The sensor of claim 10, wherein at least one of the optical detector and the optical emitter is masked by one of the capacitive sensing segments.

12. The sensor of claim 1, wherein the sensor is printed onto the container.

13. The sensor of claim 1, wherein the processor is configured to, prior to obtaining the capacitance measurements:
obtain preliminary capacitance measurements from the at least three capacitive sensing segments; and
verify that the preliminary capacitance measurements are within a predefined range and maintained over a predefined amount of time.

14. A label comprising:
a substrate, wherein the sensor of claim 1 is applied to a surface of the substrate; and
an adhesive layer applied to the substrate, the adhesive layer configured to adhere the label to the container.

15. A method comprising:
obtaining respective capacitance measurements from at least three capacitive sensing segments applied to a container;
determining an orientation of the container based on the capacitance measurements; and
determining an amount of a substance in the container based on the capacitance measurements.

16. The method of claim 15, comprising determining the amount of the substance when the orientation of the container is a neutral orientation.

17. The method of claim 16, wherein determining whether the orientation of the container is a neutral orientation comprises determining whether the capacitance measurements are within a threshold similarity to one another.

18. The method of claim 15, further comprising:
modelling projected capacitance measurements based on the orientation; and
determining the amount of the substance based on the capacitance measurements and the projected capacitance measurements.

19. The method of claim 15, further comprising performing an optical level detection operation to verify the amount of the substance in the container.

20-21. (canceled)
